(19) United States
(12) Patent Application Publication
(10) Pub. No.: US 2005/0044791 A1
(43) Pub. Date: Mar. 3, 2005

(54) Plant carriers for sealed flat roofs

(75) Inventors: Giorgio Morandini, Luzern (CH); Katja Morandini, Luzern (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: OEKAG WasserTechnik (Schweiz) AG, Luzern (CH)

(21) Appl. No.: 10/929,647

(22) Filed: Aug. 30, 2004

(30) Foreign Application Priority Data
Aug. 29, 2003 (CH) 01479/03
Oct. 20, 2003 (CH) 01782/03

(51) Int. Cl. A01G 9/02; A01C 1/04

(52) U.S. Cl. 47/65.9

(57) ABSTRACT

A plant carrier (9) for coated flat roofs lies on a buoyancy body (7) which extends over the whole plant carrier (9) and carries this independently of a water level on the flat roof always at a spacing from the water surface (h₁). The buoyancy body can be slab-shaped and perforated by vertical bores, or consist of a granular material. The dammed-up water can be used as use water.

### BACKGROUND

The invention is directed to plant carriers for sealed flat roofs, and in particular to plant carriers having a single-layer or multi-layer textile structure of fibers acting as a retaining means for plant roots.

Today, flat roofs must as a rule be green planted for esthetic and ecological reasons. A superimposed layer of substrate or gravel protects the waterproof roof covering, e.g. membrane, from mechanical damage, e.g. due to hailstorms or due to inappropriately walking thereon or letting sharp objects fall onto the roof. Green planting moreover protects the roof covering from excessive physical effects, such as ultraviolet radiation, or strong heating in summer. The longer lifetime of green-planted flat roofs is also known, because the sealing is under less microbial stress. In addition, green planting on roofs improves the climate in towns.

Plant carriers are known in many forms for green planting on flat roofs, such as gravel-adhesive roofs or climatic roofs. These mainly comprise a carrier element, e.g. a netting of biodegradable fibers, a nonwoven fabric or plastic fabric, into which plant seeds or seedlings have been inserted. After laying the netting and partially scattering with humus, the plant seeds germinate and the plant roots grow in the plant carrier. The growth and the anchoring of the roots in the netting ensure that the plants cannot be washed away or blown away by storm winds. Such plant carriers can advantageously be pre-cultivated.

In this manner, planting greenery on a surface can take place in a short time. Seeding or reseeding with extensive plant growth has not heretofore been successful in such nettings on retention roofs, i.e., roofs which hold water back or dam water up, since due to damming of water, which can last for many hours on retention roofs, plants which need a dry environment drown, and as a result water damming in plant substrates leads to the substrate becoming sour and thereby to damage to the vegetation. Marsh plants, on the other hand, wither in dry periods.

From DE-C2 19654031, a floatable textile plant island of a single-surface or plural-surface textile structure of floatable fiber materials is known. This serves for re-naturalizing water surfaces and also for protection of coastal zones. The plant island, of floating construction, can be arranged on water surfaces and if necessary also changed in location. The textile plant carrier known from this publication is particularly suitable for large, repositionable plants, but not for those for extensively planted surfaces with kinds of covering plants with small growth habit, such as Sedum or drying grasses and herbs. Laying this known plant carrier on flat roofs is unsuitable, since it can easily float away during a rainstorm, but in rainless times lies on the roof membrane and dries out, since the marsh plants have a large evaporation. In addition, the known plant carrier is not secure in storms, for which reason the producer recommends laying concrete slabs to secure the mat. However, these prevent upward floating when the roof has to take up retention water.

Flat roofs have to be inspected periodically for monitoring purposes. Walking on such floating mats is not appropriate, and paths have to be made along the mats. The green-planted roof surface is thereby reduced quite substantially.

The retention of water in plant carrier substrates of the known art is extremely moderate; it amounts to a maximum of 30-40% of the substrate volume, i.e., with a 10 cm layer thickness, 30-40 liters per m². After pore saturation, flooding occurs, and the water flows without limitations and without delay into the drain and the drainage system, and flooding can therefore take place. When not soaked, a 10-cm substrate weighs 100-130 kg/m².

### SUMMARY

The object of the invention is to provide a lightweight plant carrier for flat roofs, making possible the mechanical and general protection of the roof covering formed of a plastic membrane and simultaneously the retention of water over longer periods, without the plants forming the green planting being the basis for this.

This object is attained by a plant carrier according to the invention. Advantageous embodiments of the invention are defined in the claims.

By the omission of a round gravel covering and of the usual plant substrate of conventional flat roofs, there can be a roof load saving of 100 kg/m². With the substrate-free roof covering, it becomes possible to obtain a rapid setup and dismantling after the life cycle. Only a small amount of construction material has to be supplied to the construction location and later disposed of. In case of damage, the plant carrier can be released and rolled up. The sealing membrane of the flat roof construction can thus be quickly made visually accessible and inspected after removal of the buoyancy layer carrying the plants. A flat roof covered with the plant carrier according to the invention needs no water drainage devices or gradient constructions, and thus fewer roof drains, since higher retention damming becomes possible. In addition, the roof drains can be arranged at a suitable location, since the water is distributed over the whole of the roof surface and can flow unhindered under the plant carriers to the drains. The plant carrier, which is not itself necessarily floatable, is made of a rot-proof structured nonwoven fabric, e.g., a fine tangled structure or knitted textile, or three-dimensional filament mat. The buoyancy bodies located thereunder carry the plant carrier uniformly over the surface of the dammed-up water. As long as only interstitial water is present, the plant carrier can be trodden on without being damaged, since it does not float. The surface of the floating plant carrier is designed with a fine mesh, so that even small seeds or sprouting portions can be planted. A mat pre-culture is possible. An erosion-proof extensive green planting covering the surface is thus possible. A permanent standing water dam of 10-30 mm can be provided under the plant carrier and on the roof sealing membrane. This water supply acts to bridge over the dry periods of the vegetation. The plants can put out roots through the plant carrier floating on the water and reach the water. Independently of the dammed-up amount of water, the plants always remain above the water level. The dammed-up water can be used as use water.

The longer draining-off time made possible by the plant carriers according to the invention, for example 48 hours or more, makes it possible that very small drain surfaces can take up large quantities of water from flat roofs, or that this slowly released amount of water can be fed to a mixing drain. Inundations or hydraulic network overloads are thereby prevented.

It is furthermore possible to build up an extensive green roof planting with drought-resistant plants such as drying grasses or plants such as Sedum. These plants require very little water, and are very sensitive to long-lasting wetness. The plant carrier according to the invention makes possible the growth of an intensive vegetation of this plant association, since on the one hand a water supply is always present, and on the other hand an inundation is excluded. The water supply to the plant carrier can be set by a suitable choice of the buoyancy body. The weight of the bulk material acting as the buoyancy body and the weight of the plant carrier are sufficient to be able to dispense with a windproof fastening of the membrane seal.

### BRIEF DESCRIPTION OF THE DRAWINGS

The invention is described in further detail based on the exemplary embodiments shown in the drawings.

FIG. 1 is a partial cross section through a roof region ending at a concrete parapet;

FIG. 2 is a detail view of a fastening of the plant carrier in FIG. 1;

FIG. 3 is a plan view of a flat roof;

FIG. 4 is a vertical section view through a green-planted plant carrier with a water carried buoyancy body;

FIG. 5 is a vertical section view through a further green-planted plant carrier; and

FIG. 6 is an enlarged vertical section view through a green-planted plant carrier according to FIG. 5.

### DETAILED DESCRIPTION OF THE PREFERRED EMBODIMENTS

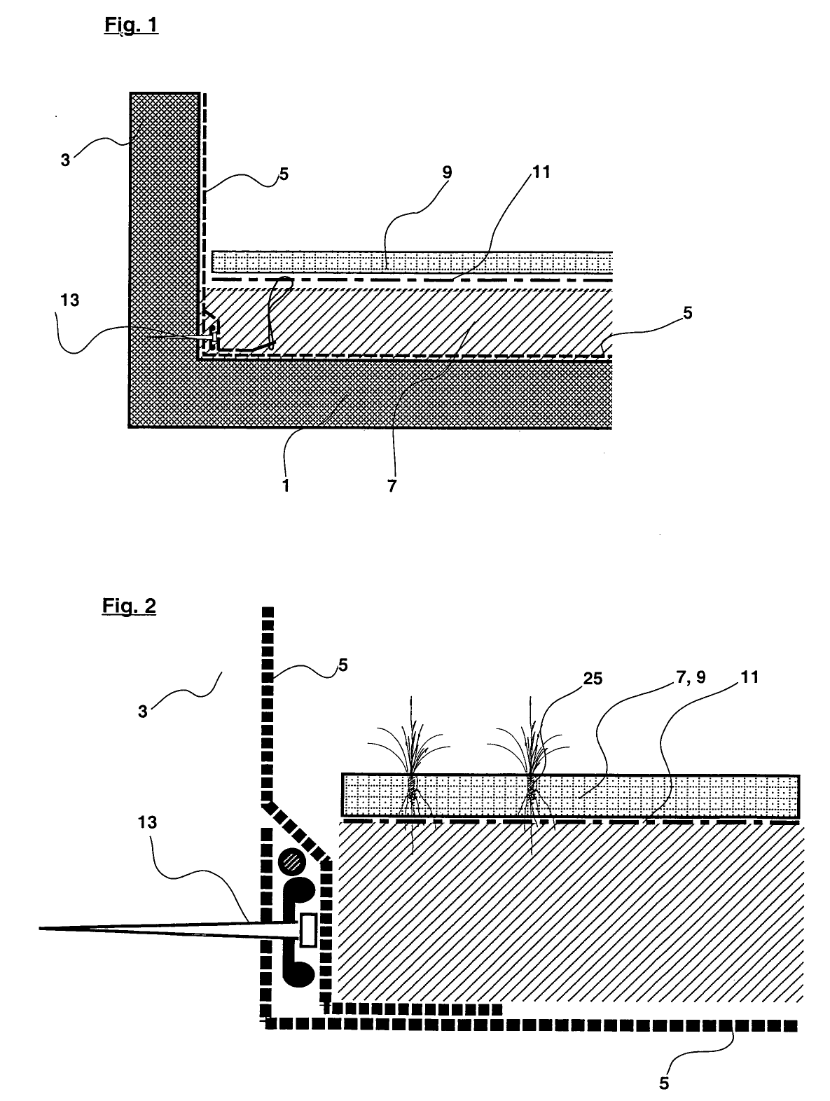

In the edge region of a flat roof, shown schematically, a roof slab is indicated by reference 1, and is adjoined by a parapet wall 3. The roof slab construction is freely selectable, e.g. support profile or concrete. A membrane 5 of plastic, synthetic rubber, or asphalted board, or other sealing material, is laid on the roof surface and the inner side of the wall. The membrane 5 acts as a water barrier toward the building, i.e. toward the roof slab 1 and wall 3. Shown in FIG. 1 schematically as a block 7, a buoyancy body, to be described in detail hereinafter, lies on the membrane 5. A plant carrier 9 is located over the buoyancy body 7 and is formed of a tangled fleece or tangled structure of synthetic fibers or the like. Between the buoyancy body 7 and the plant carrier 9, or over the plant carrier 9, a grid or netting 11 can be arranged, which is anchored by a suitable means 13 at least along the parapet wall 3, and prevents lifting-off of the plant carrier 9 and buoyancy body 7 by a strong wind.

FIG. 2 shows an anchoring device with the anchoring means 13 in an enlarged illustration.

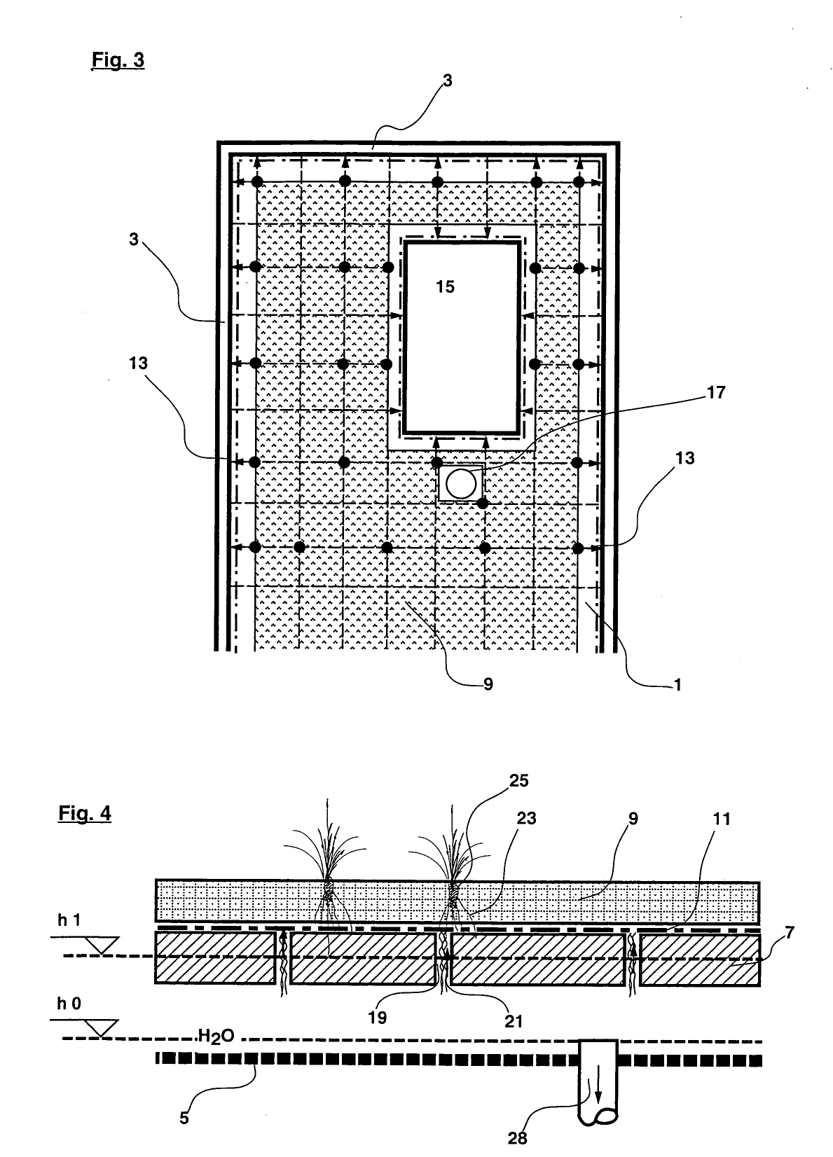

In FIG. 3, which shows a plan view of a flat roof, there can be seen the parapet wall 3 and the plant carrier 9 lying on the roof surface, and also the grid 11 with the anchoring means 13. Anchoring means 13 can also be provided along an attic structure or elevator structure 15, and likewise in the region of a chimney 17 which passes through the plant carrier 9. A perforation of the membrane by fastening pins anchored in the roof slab is omitted.

In the embodiment of the invention according to FIG. 4, the buoyancy body 7 comprises a slab whose specific weight is less than 1.0 and through which pass vertical bores 19 extending from the underside to the upper side. Particularly when a wick 21 or other water-conveying means is inserted therein, water lying on the membrane 5 can be conveyed to the plant carrier 9 through the bores 19. The roots 23 of the plants 25 are thereby supplied with water, without directly lying in water. The level h₁ of the water dammed up on the roof 5 lies about in the middle of the buoyancy body 7, according to the thickness of the plant carrier 9 and the specific density of the buoyancy body 7. By a suitable arrangement of the roof drain 28, the inlet height ho of which lies above the membrane 5, drying out of the plant carrier can be prevented when no precipitation falls for a long time. With a suitably constructed throttling of the water runoff, a correspondingly large amount of retention water can be held back on the roof when there is a great occurrence of rain, and thereafter conducted away in a controlled manner over days or weeks. Independently of whether much or little water lies beneath the buoyancy body 7, the plants 25 growing on the plant carrier 9 are always supplied with as much water as they need.

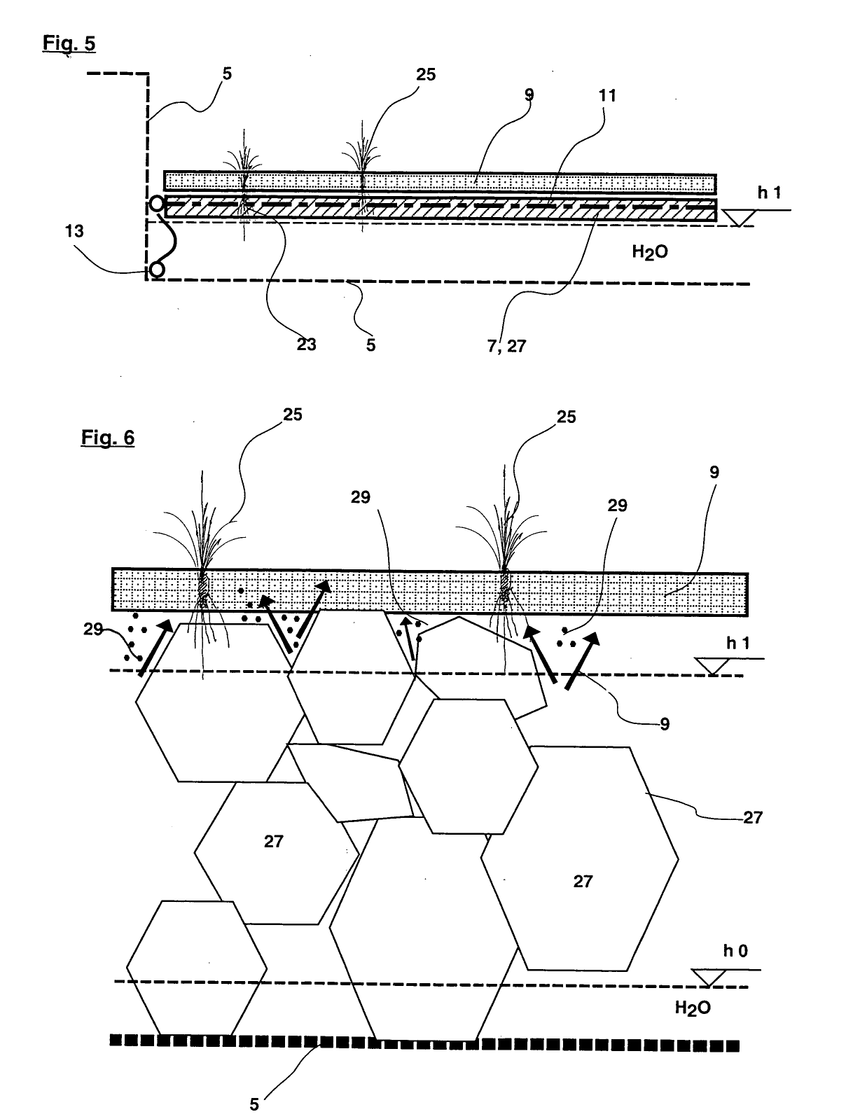

In the embodiment of the invention according to FIG. 5, the buoyancy body 7 no longer is formed of a large-surface element, but of numerous larger or smaller buoyancy elements 27 of granular, hollow body, or spherical form, which are installed on the membrane 5 as bulk material before the plant carrier 9 is laid thereon. The granular or spherical buoyancy bodies 27 can be hollow bodies or closed-pore foams of organic or inorganic materials. These act on the one hand as buoyancy and carrier bodies for the plant carrier 9 and on the other hand moisture is transported through their pores and over their surface upward into the plant carrier 9. This kind of light buoyancy bodies has the advantage that it can be installed on the flat roof as bulk material and, in the case of a flat roof restoration, can be removed again by simple means, e.g. by vacuuming. Furthermore, no preparatory work has to be undertaken, since the bulk material, which floats on a water surface, becomes uniformly distributed of itself. Bulk materials can be washed and re-used. Moreover the bulk material, when it no longer floats because the water level has fallen so far that the bulk material comes to abut on the membrane 5, can directly be trodden on. Consequently no access paths and the like are necessary.

FIG. 6 shows an enlarged excerpt from the diagram in FIG. 5; from it the construction of the buoyancy body 7 with the granular individual buoyancy bodies 27 can be seen. Furthermore, the minimum water level ho and the maximum water level h₁ can be seen. In particular, with the maximum water level it is evident that a portion of the buoyancy body is arranged above the water surface h₁, so that in this region, above which lies the plant carrier 9, no water is present, only high air moisture (humidity) (indicated by the arrow 29). The moisture 29 further propagates or rises into the plant carrier 9. According to the surface nature of the granular material 27, more or less water is conveyed upward, corresponding to the needs of the plants 25 growing there.

1. Plant carrier (9) for flat roofs, comprising a single-layer or multi-layer textile structure of fibers that acts to retain plant roots, wherein the plant carrier (9) is located on a water-permeable buoyancy body (7) which extends generally uniformly under the plant carrier (9) and which carries an underside of the plant carrier (9) at a spacing above a water level on the roof.

2. Plant carrier according to claim 1, wherein the buoyancy body (7) comprises a slab of a material with a specific density <1.0 and perforated by bores or channels (19) connecting a bottom side of the buoyancy body with an upper side.

3. Plant carrier according to claim 2, wherein wicks for transporting water are inserted into the bores or channels (19).

4. Plant carrier according to claim 1, wherein the buoyancy body (7) is formed of numerous granular or hollow body bulk material elements (27).

5. Plant carrier according to claim 4, wherein the individual buoyancy elements (27) have the same or different sizes.

6. Plant carrier according to claim 4, wherein the buoyancy elements (27) have a specific density <1.0.

7. Plant carrier according to claim 1, wherein a grid or netting (11) of rot-proof material is arranged beneath, in, or above the plant carrier (9).

8. Plant carrier according to claim 7, wherein the grid or netting (11) is anchored on the flat roof along the edges of the plant carrier (9), and/or an anchoring of the roof sealing is omitted because of a weight of the plant carrier, the buoyancy body, and the dammed-up water.

9. Plant carrier according to claim 1, wherein a sealed roof membrane (5) can be laid without a gradient.

10. Plant carrier according to claim 1, wherein a height of dammed water h₀-h₁ is freely selectable and the roof holds a reservoir of use water.
